(19) United States
(12) Patent Application Publication
(10) Pub. No.: US 2007/0014631 A1
(43) Pub. Date: Jan. 18, 2007

(54) Stress defender holes

(76) Inventor: Stefan J. Wagner, Derby (GB)

Correspondence Address: MANELLI DENISON & SELTER, 2000 M STREET NW SUITE 700, WASHINGTON, DC, 20036-3307, US

(21) Appl. No.: 11/504,632

(22) Filed: Aug. 16, 2006

Related U.S. Application Data
(63) Continuation-in-part of application No. 10/462,644, filed on Jun. 17, 2003.

(30) Foreign Application Priority Data
Jul. 13, 2002 (GB) 0216362.4

(51) Int. Cl. F16D 1/00

(52) U.S. Cl. 403/408.1

(57) ABSTRACT

A stress defender hole (18) in a component is provided with a countersunk portion (19). The countersunk portion (19) increases the stress concentration on to the defender hole (18), hence reducing stress elsewhere in the component.

The present invention relates to stress defender holes. In particular, it relates to a novel form of stress defender hole which finds particular application when the position and/or size of the hole is constrained.

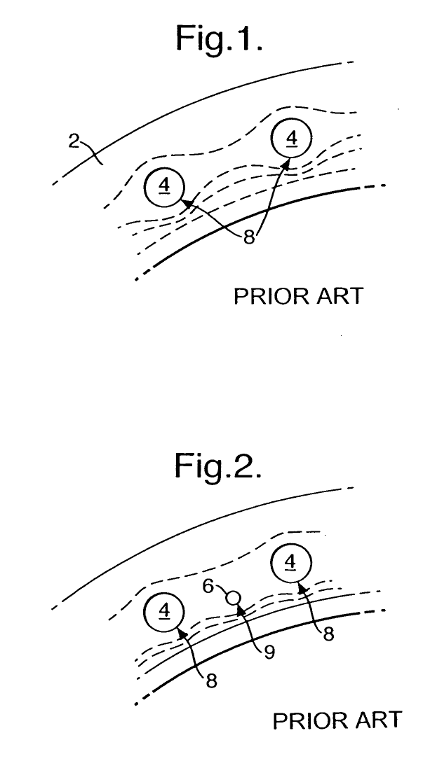

FIG. 1 illustrates part of an annular flange 2 with holes 4 therethrough. The holes 4 are for receiving bolts which are used to connect the flange to another flange. The figure illustrates the stress lines within the flange 2, as dotted lines. If the peak stress at positions 8, exceeds a threshold then the flange 2 may be compromised. It is therefore known to introduce stress defender holes 6 into the flange 2 as illustrated in FIG. 2. The stress defender hole 6 is positioned between the bolt holes 4. Whereas the bolt holes 4 lie at a constant radius R1 from the axis of the flange, the stress defender hole is positioned at a radius R2 which is less than R1. As R2 is decreased, the stress defender hole 6 moves into the stress field. The stresses within the flange 2 are therefore concentrated upon the stress defender hole 6 at position 9 and not upon the positions 8. It is possible to reduce the stress on the bolt holes 4, by increasing the size of the stress defender hole 6 or by reducing the radius R2.

A problem, however, arises if there are constraints on the size and/or the position of the stress defender hole 6. In these circumstances, the stress defender hole 6 cannot be positioned or sized to reduce the stress on the bolt holes below the threshold value. Embodiments of the present invention address this problem.

According to one aspect of the present invention there is provided an assembly of components comprising a first component (e.g. a flange) and a second component (e.g. a bolt). The first component comprises a first surface, which has a first circular opening, and a second surface, which has a second circular opening aligned with the first circular opening. A hole having at least first and second portions connects the first and second circular openings. The first component has a first cylindrical wall portion which defines the first hole portion and has a second wall portion that extends from the second surface to the first cylindrical wall portion and defines the second hole portion and the second opening. The second component comprises a substantially cylindrical portion, which extends through the first component via the hole contacting the first wall portion of the first component but not contacting the second wall portion of the first component.

The second wall portion defining the second hole portion and the second opening are sized to reduce the stress at critical regions of the first component below a threshold. The size and/or position of the first wall portion may be constrained by the second component.

The first component may have at least one additional hole extending from the first surface to the second surface, wherein the second wall portion defining the second hole portion and second opening takes stress from the additional hole.

The assembly may additionally comprise a third component, for receiving the second component, that constrains the position and dimensions of the first wall portion.

According to another aspect of the present invention there is provided a component comprising a surface having a first circular opening to a first hole and a second opening to a second hole. The first hole has at least first and second hole portions. The component comprises a first cylindrical wall portion, which defines the first cylindrical hole portion, and a second wall portion, which extends from the surface to the first cylindrical wall portion and defines the second hole portion and the first circular opening. The second wall portion, which defines the second hole portion and the first circular opening, is dimensioned to remove stress from the second opening.

The first and second openings are normally adjacent. The second wall portion may be bevelled thereby defining a frusto-conical shaped second hole portion. In this case the bevelled second wall portion is preferably at an angle of substantially 45 degrees to the surface. Alternatively, the second wall portion may be cylindrical thereby defining a cylinder shaped second hole portion.

For a better understanding of the present invention reference will now be made by way of example only to the accompanying drawings in which:

FIG. 1 illustrates stress fields in a flange with bolt holes;

FIG. 2 illustrates the effect of a stress defender hole;

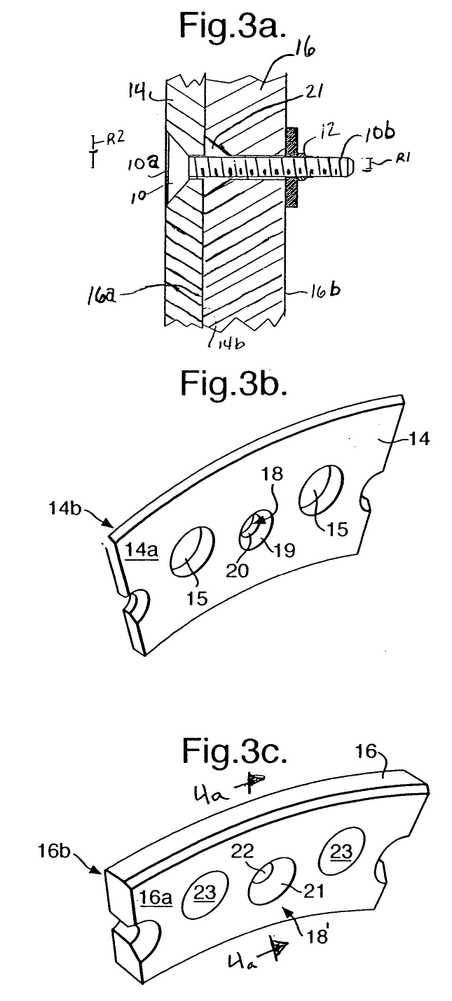

FIG. 3a illustrates a cross-sectional view of an assembly according to one embodiment of the present invention;

FIG. 3b shows a perspective view of a first flange;

FIG. 3c shows a perspective view of a second flange;

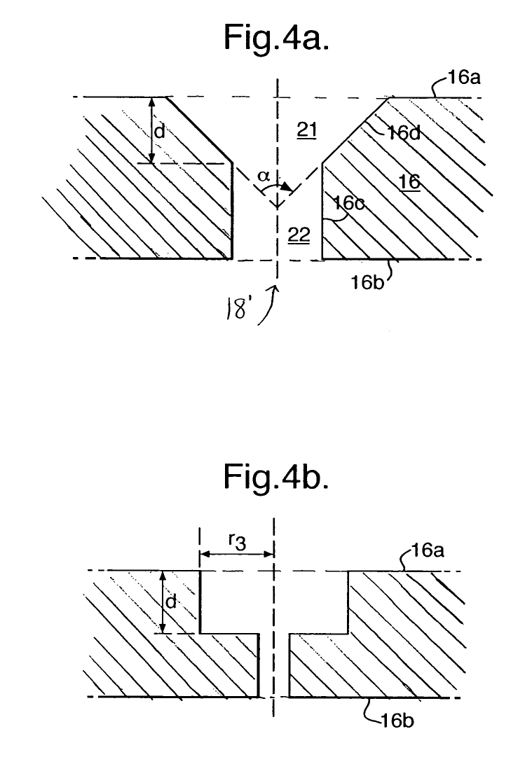

FIG. 4a illustrates a cross-sectional view of the second flange along lines 4a-4a of FIG. 3c; and

FIG. 4b illustrates alternative dimensioning for the stress reducing hole illustrated in FIG. 4a.

FIGS. 3a, 3b and 3c illustrate an interconnected arrangement (or assembly) of component parts in accordance with one embodiment of the present invention. In the arrangement, a first metal flange 14 is connected to a second flange 16 by fastening means which in this example is a metal bolt 10 and nut 12. The bolt has a head portion 10a and a body portion 10b. The body portion 10b is substantially cylindrical in shape with a radius of R1. The head portion 10a is circular in shape and has a radius R2 which is greater than R1.

The first flange 14 has a front face 14a and a back face 14b. The flange 14 has two bolt holes 15 extending from the front face 14a to the back face 14b. The first flange 14 also has a stress defender hole 18 which is circular in shape and extends from the front face 14a to the back face 14b. The stress defender hole 18 has two portions—a countersunk portion 19 for receiving the bolt head 10a and an engaging portion 20 for contacting the body 10b of the bolt 10. The engaging portion 20 is cylindrical in shape and has a radius just greater than R1 so that the body of the bolt 10 fits snugly within it. The countersunk portion 19 is of a standard type and the bevelled portions of the first flange 14 defining the countersunk portion 19 subtend an angle of 100° at the axis of the bolt 10. The opening which the countersunk portion 19 makes at the front face 14a of the first flange 14 has a radius just greater than R2, so that the bevelled head 10a of the bolt 10 is received therein.

The third component, i.e., second flange 16 has a front face 16a and a back face 16b. There are two bolt holes 23 which extend from the front face 16a to the back face 16b. These bolt holes 23 are aligned in the arrangement with the bolt holes 15 of the first flange 14. The second flange 16 also has a stress defender hole 18′ which is circular in shape and extends from the front face 16a to the back face 16b of the second flange 16. The stress defender hole 18′ in the second flange 16 is aligned with the stress defender hole 18 in the first flange 14 and has two portions: a stress defending portion 21 and an engaging portion 22. The stress defending portion 21 has a frusto-conical shape forming a circular opening in the front face 16a of the second flange 16. This opening has a radius R3 which is greater than R1. The engaging portion 22 of the stress defender hole 18′ in the second flange 16 extends from the rear face 16b of the second flange and joins with the stress defending portion 21. The engaging portion 22 has a cylindrical shape with a radius just greater than R1 so that the body of the bolt 10 can be snugly received therein. The frusto-conical stress defending portion 21, the cylindrical engaging portion 22, the cylindrical engaging portion 20 and the bevelled countersunk portion 19 are all coaxial.

FIG. 4a illustrates a cross-section along lines 4a-4a of FIG. 3c illustrating the stress defender hole 18′ of the second flange 16. The stress defender hole 18′ has a cylindrical engaging part 22 defined by the side walls 16c of the second flange 16 and a frusto-conical stress defending portion 21 defined by the bevelled side walls 16b of the second flange 16. The bevelled walls 16d of the second flange subtend an angle of a at the axis of the stress defender hole 18′. This angle α is preferably 90°. The stress defending properties of the stress defending portion 21 may be adapted by varying the angle α, the depth d or radius R3 of the frusto-conical section defining the stress defending portion 21.

Referring to FIG. 3a, when the first flange 14 is bolted to a third component which is the second flange 16 using the bolt 10 the rear face 14b of the first flange and the front face 16a of the second flange 16 make contact. The cylindrical body portion 10b of the bolt 10 extends through the portion of the stress defender hole 18′ defined by the second flange 16. The side walls 16c of the second flange 16 defining the engaging part 22 of the stress defender hole 18′ engage the body 10b of the bolt 10. The bevelled side walls 16d of the flange 16 which define the frusto-conical stress defending portion 21 of the stress defender hole 18′ do not make contact with the bolt 10. Thus the stress defending portion 21 is unoccupied and forms an occlusion within the arrangement.

In the foregoing description, the stress defending portion 21 of the stress defending hole 18′ in the second flange 16 was frusto-conical. According to another embodiment, illustrated in FIG. 4b, the stress defending portion 21 may be cylindrical in shape with the cylinder having a radius R3. The radius R3 and the depth D of the stress defending portion 21 may be altered to vary the stress defending properties of the stress defender hole 18′.

In the foregoing description a particular attachment means is described, namely a bolt. However other attachment means could be used such as screws. In this case the side walls 16c of the second flange would be substantially but not exactly cylindrical as they would include threads for receiving corresponding threads of the screw.

Although the present invention has been described in the preceding paragraphs with reference to various examples, it should be appreciated that modifications and variations to the examples given can be made without departing from the scope of the invention as claimed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A component which is subject to a stress field, has a plurality of first holes extending through said component, said component additionally having a plurality of stress defender holes extending therethrough, said stress defender holes being positioned between said first holes so that the stress field within said component is concentrated upon said stress defender holes, characterised in that each of said stress defender holes comprises a first portion of generally cylindrical configuration and a second portion terminating at a surface of said component to define a circular opening having a diameter greater than that of said generally cylindrical first portion, said first and second stress defender hole portions being coaxial.

2. A component as claimed in claim 1 characterised in that said second portion of each of said stress defender holes is of frusto-conical configuration.

3. A component as claimed in claim 2 characterised in that said frusto-conical portion is at an angle of substantially 45 degrees to said component surface.

4. A component as claimed in claim 1 characterised in that said second portion of each of said stress defender holes is of generally cylindrical configuration.

5. A component as claimed in claim 1 characterised in that said component is positioned adjacent a further component having a plurality of first holes corresponding and aligned with said first holes in said first component, and a plurality of stress defender holes corresponding and aligned with said stress defender holes in said first component said first holes in said first and further components receiving bolts to facilitate the attachment of said first and further components to each other.

6. A component as claimed in claim 5 characterised in that corresponding stress defender holes in each of said components are aligned to receive further bolts to facilitate the attachment of first and further components to each other.

7. A component as claimed in claim 1 characterised in that said component is in the form of a flange.

8. A component as claimed in claim 7 characterised in that said flange is of circular configuration.

9. A component as claimed in claim 1 characterised in that said component comprises a portion of a gas turbine engine.
